(19) United States
(12) Patent Application Publication
(10) Pub. No.: US 2007/0031613 A1
(43) Pub. Date: Feb. 8, 2007

(54) Method and apparatus for storing wire ornament hangers

(76) Inventor: Robert M. Foster II, Phoenix, AZ (US)

Correspondence Address: TOD R NISSLE, PO BOX 55630, PHOENIX, AZ, 85078, US

(21) Appl. No.: 11/198,372

(22) Filed: Aug. 5, 2005

(51) Int. Cl. G09F 17/00; A47G 35/00

(52) U.S. Cl. 428/7; 428/542.2

(57) ABSTRACT

A method and apparatus for storing wire ornament hangers. Christmas ornaments are adapted to carry wire ornament hangers and other articles. The ornaments are stored on a Christmas tree or in a container that is opened during the holiday season.

This invention relates to Christmas ornaments.

More particularly, the invention relates to a method and apparatus for storing and utilizing wire ornament hangers and other ornament components and articles.

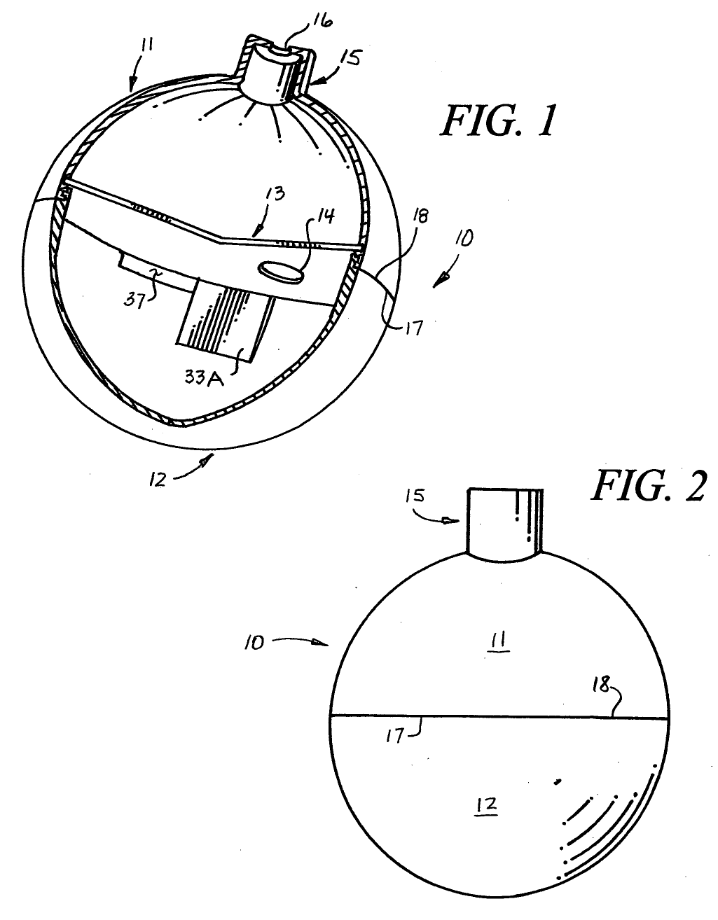

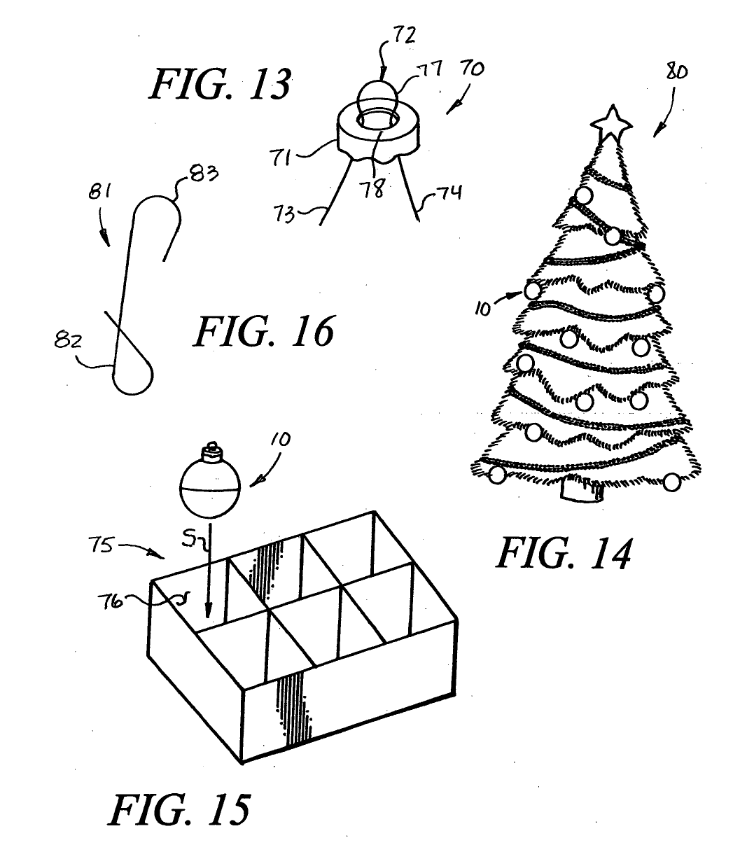

Christmas ornaments customarily include a collar unit 70 (FIG. 13) that is mounted on the neck 15 (FIG. 1) at the top of the ornament. The collar includes a hollow cylindrical cap 71 that fits over and seats on the top of the neck 15, and includes a spring, or wire, 72. The legs 73 and 74 of wire 72 are resiliently squeezed together and directed through aperture 78 of cap 71 and through aperture 16 of neck 15 to a position inside neck 15 and ornament 10. Legs 73 and 74 then resiliently spring apart to the normal operative position illustrated in FIG. 13 and, in this normal operative position, function to retain unit 70 on neck 15. The bottom 82 of a wire ornament hanger 81 (FIG. 16) is inserted through hoop or eye 77 of wire 72 to connect hanger 81 to unit 70. Hook 83 is used to hang ornament 10 on a Christmas tree or wreath or other desired place. Collar unit 70 can, instead of spring 72, include a hanger made from string or any other desired material. When string is utilized, a loop of string typically is formed and the end of the string inside ornament 10 is tied into a knot that is larger than aperture 16 and is large enough to prevent the knot from being pulled outwardly through aperture 16.

Wire ornament hangers 81 and collar units 70 tend to readily detach from ornaments and to be misplaced. Replacement hangers 81 can be purchased, but typically are sold packaged on cardboard with a plastic cover that, once opened, is not resealable. Consequently, once the plastic cover is opened, hangers 81 can readily fall out of the package. Since wire hangers 81 and ornaments are often inexpensive, one solution to the problem is simply to discard ornaments that have lost the collar unit 70 and to discard excess wire hangers that fall from their packaging or that fall from an ornament 10. That is an expedient solution. A principal disadvantage is that when ornaments lose their collar unit 70, the neck 15 tends to get chipped, producing sharp pieces that can, along with hangers 81 and collar units 70 be readily ingested by animals and small children. Although preventing the loss of hangers 81 and collar units 70 and allowing for ready storage and access to the same would be useful, the safety of animals and small children is believed at least equally important.

Accordingly, it would be highly desirable to provide an improved method and apparatus that would, when using Christmas ornaments, reduce the likelihood that children or animals ingest or be otherwise injured by parts or pieces of the Christmas ornaments.

Therefore, it is a principal object of the invention to provide a method and apparatus for storing, dispensing, and utilizing wire hangers and collar units found on Christmas ornaments.

These and other, further and more specific objects and advantages of the invention will be apparent to those of skill in the art from the following detailed description thereof, taken in conjunction with the drawings, in which:

FIG. 1 is a partial section perspective view illustrating a Christmas ornament constructed in accordance with the principles of the invention;

FIG. 2 is a front view further illustrating the ornament of FIG. 1;

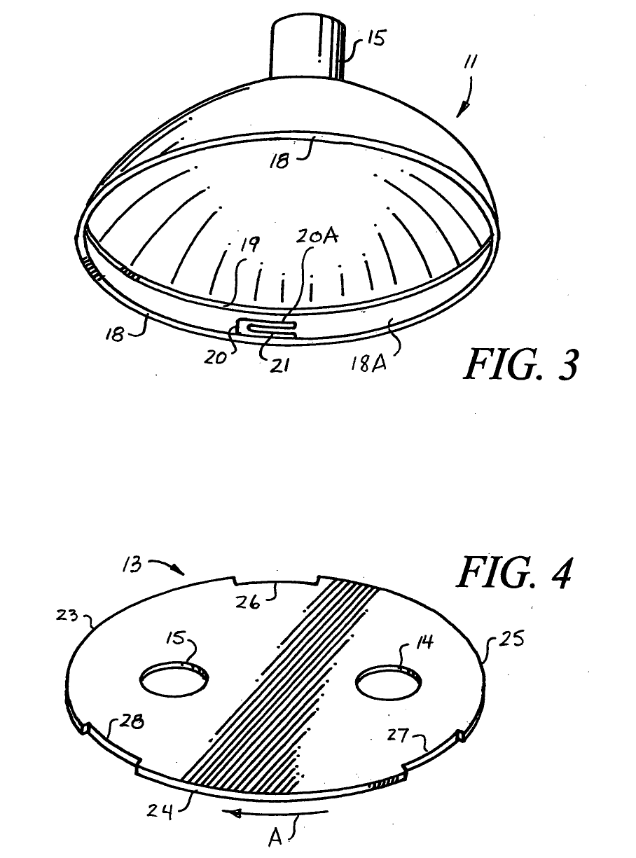

FIG. 3 is a bottom perspective view of the hollow top portion of the ornament of FIG. 1 illustrating additional construction details thereof;

FIG. 4 is a perspective view illustrating a removable panel member that is utilized in the interior of the ornament of FIG. 1;

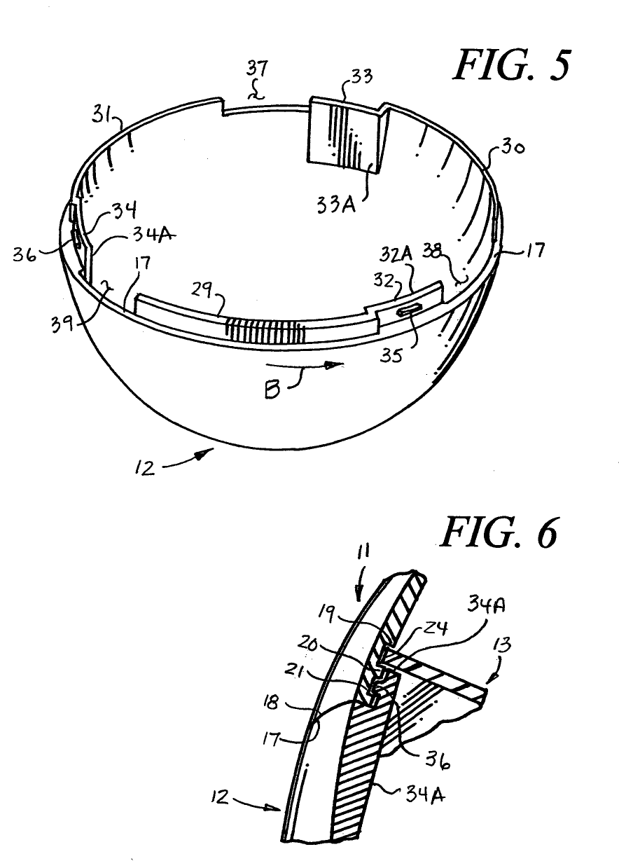

FIG. 5 is a top perspective view of the hollow bottom portion of the ornament of FIG. 1 illustrating additional construction details thereof;

FIG. 6 is a side section view of a portion of the ornament of FIG. 1 illustrating the interconnection of the top and bottom portions of the ornament and illustrating the mounting of the panel member of FIG. 4 in the ornament;

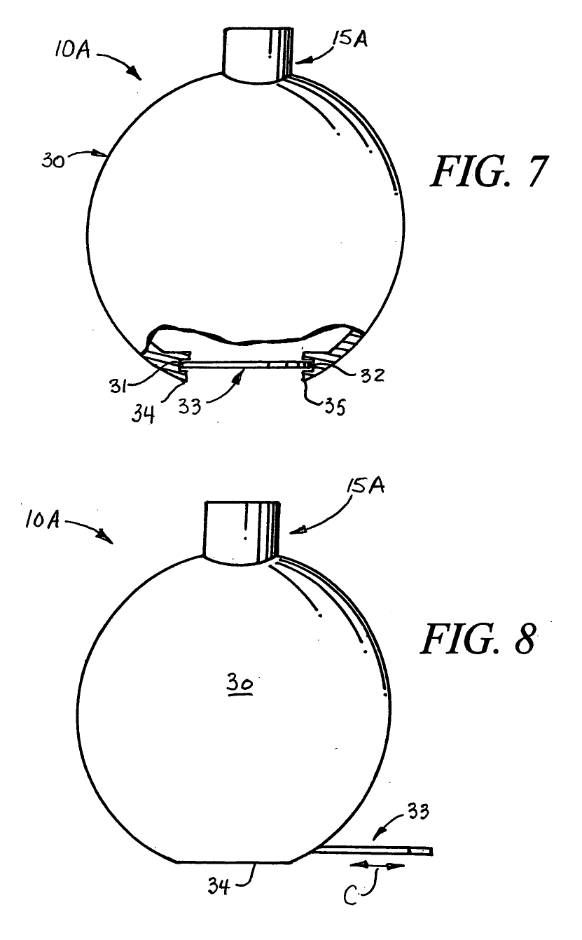

FIG. 7 is a front view illustrating an ornament utilized in an alternate embodiment of the invention;

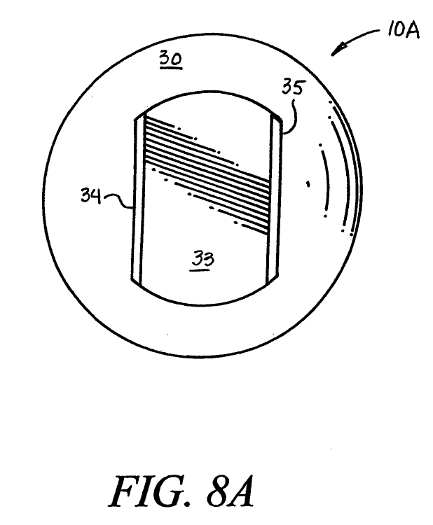

FIG. 8 is a side view of the ornament of FIG. 7 illustrating the mode of operation thereof;

FIG. 8A is a bottom view further illustrating the ornament of FIG. 6;

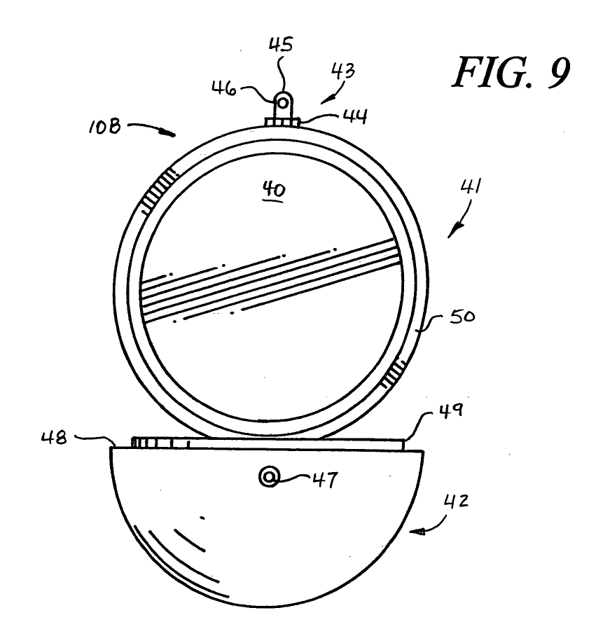

FIG. 9 is a front view illustrating an ornament utilized in another embodiment of the invention;

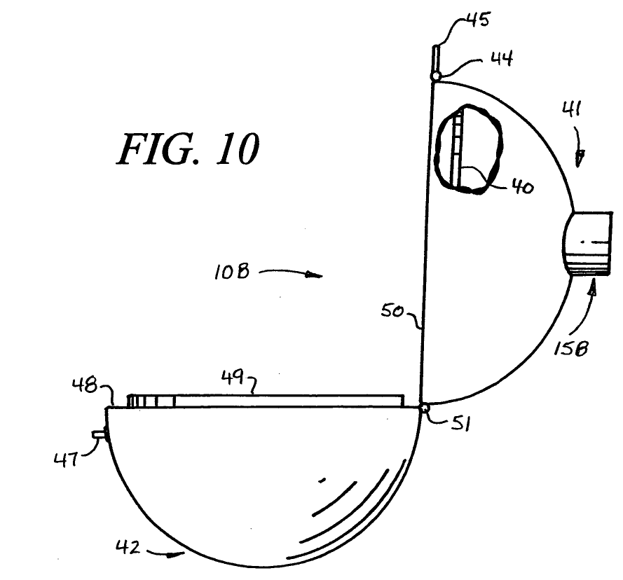

FIG. 10 is a side view of the ornament of FIG. 9 further illustrating construction details thereof;

FIG. 11 is a front view illustrating an ornament utilized in still another embodiment of the invention;

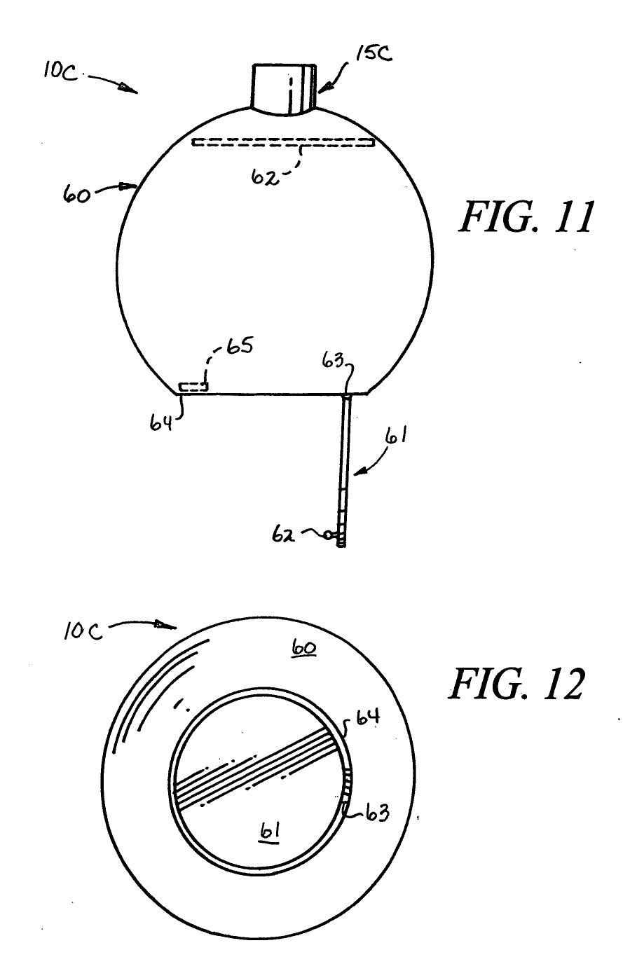

FIG. 12 is a bottom view further illustrating the ornament of FIG. 11;

FIG. 13 is a perspective view illustrating a conventional ornament collar unit;

FIG. 14 is a front view illustrating a Christmas tree utilized in one embodiment of the invention;

FIG. 15 is a perspective view illustrating an ornament storage box utilized in another embodiment of the invention; and,

FIG. 16 is a front view illustrating a conventional wire ornament hanger.

Briefly, in accordance with the invention, I provide an improved method for storing wire ornament hangers, ornament collar units, and Christmas lights. The method comprises the step of providing a Christmas ornament. The ornament comprises a hollow body having an interior; a neck; a collar unit mounted on the neck; a wire ornament hanger attached to the collar unit; a manually operable structure to access at least a portion of the interior of the body and having at least two operative positions, a first open operative position to take wire ornament hangers or ornament collar units or Christmas lights in and out of the interior, and a second closed position closing the wire ornament hangers or ornament collar units or Christmas lights in the interior of the Christmas ornament. The method also comprises the steps of manually operating the structure to the first open operative position; inserting wire ornament hangers or ornament collar units or Christmas lights in the interior; manually operating the structure to the second closed position; and, using the wire ornament hanger to hang the ornament on a Christmas tree to store the wire ornament hangers or ornament collar units or Christmas lights.

In another embodiment of the invention, I provide an improved method for storing wire ornament hangers, ornament collar units, and Christmas lights. The method comprises the step of providing a Christmas ornament. The ornament comprises a hollow body having an interior; a neck; a collar unit mounted on the neck; a wire ornament hanger attached to the collar unit; a manually operable structure to access at least a portion of the interior of the body and having at least two operative positions, a first open operative position to take wire ornament hangers and ornament collar units and Christmas lights in and out of the interior, and a second closed position closing the wire ornament hangers and ornament collar units and Christmas lights in the interior of the Christmas ornament. The method also comprises the steps of manually operating the structure to the first open operative position; inserting wire ornament hangers or ornament collar units or Christmas lights in the interior; manually operating the structure to the second closed position; and, using the wire ornament hanger to hang the ornament on a Christmas tree to store the wire ornament hangers or ornament collar units or Christmas lights.

In a further embodiment of the invention, I provide an improved Christmas ornament comprising a hollow body having an interior; a top; a wire ornament hanger attached to said top; a manually operable structure to access at least a portion of the interior of the body and having at least two operative positions, a first open operative position to take articles in and out of the interior, and a second closed position closing articles in the interior of the Christmas ornament; and, articles stored in the interior of the Christmas ornament.

Turning now to the drawings, which depict the presently preferred embodiments of the invention for the purpose of illustration thereof, and not by way of limitation of the invention, and in which like characters refer to corresponding elements throughout the several views, FIG. 1 illustrates a Christmas ornament constructed in accordance with the invention and generally indicated by reference character 10. Ornament 10 includes top portion 11 and bottom portion 12. Top portion 11 includes hollow neck 15 with aperture 16 formed therethrough. Top portion 11 includes lip 18. Bottom portion 12 includes lip 17 opposed to lip 18. A collar unit 70 (FIG. 13), not shown in FIG. 1, is normally mounted and seated on the top of heck 15 in conventional fashion with the legs 13 and 14 of spring 72 extending through aperture 16 into the interior of ornament 10. Generally circular panel 13 is removably secured and mounted in top portion 11.

FIG. 3 illustrates in more detail the top portion 11 of Christmas ornament 10. The lower edge of top portion 11 is completely circumscribed by circular lip 18. Panel 13 (not shown in FIG. 3) seats against inner circular lip 19 when panel 13 is mounted in top portion 11. U-shaped outwardly extending member 20 includes slot or groove 21 that slidably receives one of the three outwardly extending nubs or ribs 35, 36 of bottom portion 12. There are three equally spaced members 20 formed on inner surface 18A of top portion 11. Only one of the three members 20 is visible in FIG. 3.

FIG. 4 illustrates panel 13 in more detail. Panel 13 includes outer peripheral arcuate edge portions 23 to 25. Each portion 23 to 25 lies along a common circle and has a length equivalent to the length of each of the other portions 23 to 25. Indent or slot 28 is formed intermediate edge portions 23 and 24. Indent or slot 27 is formed intermediate edge portions 24 and 25. Indent or slot 26 is formed intermediate edges portions 23 and 25. Slots 26 to 28 are equally spaced. The distances between slots 26 to 28 are generally equivalent to the distances between members 20. Each slot 26 to 28 is, when panel 13 is inserted inside top portion 11, shaped to slid over one of members 20. Once slots 26 to 28 each slide over a member 20 and the outer peripheral edge portions 23 to 25 are seated against lip 19, a user places his thumb and forefinger through apertures 14 and 15 (assuming the user's thumb and forefinger are not already in said apertures) and manually rotates panel 13 a short distance in the direction of arrow A. Rotating panel 13 in the direction of arrow A moves slots 26 to 28 away from members 20 so that a portion of one of the peripheral edge portions 23 to 25 is positioned over and against an outwardly extending upper edge 20A of member 20 such that panel 13 is supported and retained in position against lip 19. Panel 13 is removed from top portion 11 by reversing the procedure, i.e., by rotating panel 13 until slots 26 and 28 are each in alignment and registration with a member 20, which permits slots 26 to 28 to each slid downwardly over a member 20 and out of top portion 11. If desired, instead of forming apertures 14 and 15 in panel 13 to be used to rotate panel 13, a small upstanding outwardly extending tab or handle can be formed in or fixedly connected to the center of panel 13. The tab is grasped between the thumb and forefinger and is turned to rotate panel 13 simultaneously with the handle.

Bottom portion 12 is illustrated in more detail in FIG. 5. Lip 17 completely circumscribes the upper section of portion 12. Upper edge 30 is connected to upper edge 33. Member 33A includes upper edge 33. Upper edge 31 is connected to upper edge 34. Member 34A includes upper edge 34. Upper edge 29 is connected to upper edge 32. Member 32A includes upper edge 32. Members 32A, 33A, and 34A are each of equal shape and dimension. Edges 29, 30, 31 are each of equal shape and dimension. Spaces 37, 38, 39 are each of equal shape and dimension. Space 37 extends over lip 17 between member 33A and edge 31. Space 38 extends over lip 17 between member 32A and edge 30. Space 39 extends over lip 17 between member 34A and edge 29. Rib 35 extends outwardly from member 32A. Rib 36 extends outwardly from member 34A. A rib similar to rib 35 and 36 extends outwardly from member 33A, is not visible in FIG. 5, and has a shape and dimension equal to that of each rib 35 and 36. When bottom portion 12 is attached to top portion 11, edges 29 to 30 slide upwardly into top portion 11 such that each member 20 is position in a space 37 to 39. Bottom portion 12 (or portion 11 or both portions 11, 12 simultaneously) is rotated in the direction of arrow B to turn each rib 35, 36 into interlocking relationship with a slot 21 in a member 20. The interlocking, interfitting relationship between panel 13, top portion 11, and bottom portion 21 (when assembled in the manner illustrated in FIGS. 1 and 2) is more readily viewed in FIG. 6. In FIG. 6, the interlocking relationship of a member 20 with rib 36 is illustrated, along with the position of an edge 24 of panel member 13 intermediate lip 19 and the top 20A of member 20. Wire ornament hangers 81 or collar units 70 or springs 72 or collars 71 can be stored in the interior of hollow bottom portion 12 or in the interior of hollow top portion 11. Since, however, hangers 81 or springs 72 might protrude out through neck 15, it is presently preferred that hangers 81, units 70, springs 72, and/or collars 71 be stored in bottom portion 12 such that panel 13 functions as a divider that generally maintains hangers 81, etc. in the bottom portion 12. Any desired article or articles can be stored inside ornament 10. Panel 13 can, if desired, not be utilized in ornament 10 in order to increase the size of the storage space available in ornament 10. The shape and dimension or ornament 10 can vary as desired. Ornament 10 need not be spherical.

When panel 13 is utilized in ornament 10, one kind of article can be stored in bottom portion 12 and another kind of article can be stored in top portion 11. For example, wire hangers 81 can be stored in bottom portion 12 and Christmas lights can be stored in top portion 11. As used herein, Christmas lights are light bulbs used in strands of lights that are placed on a Christmas tree. Christmas lights include, for example, the small “twinkle” sized light bulbs and other larger light bulbs found in strands of lights for Christmas trees. Christmas light bulbs are found in a variety of colors including, for example, red, green, blue, yellow, and “white” light bulbs consisting of clear glass and a filament that glows white when the light bulb is on.

FIGS. 7, 8, 8A illustrate an alternate embodiment of a Christmas ornament used in the practice of the invention. Ornament 10A includes hollow, generally spherical body 30 provided with a hollow, conventional neck 15A shaped and dimensioned to receive a collar unit 70. The bottom of body 30 is provided with a pair of parallel, spaced apart linear slots 31, 32 shaped to slidably receive in the direction of arrows C a door 33. Door 33 is in the closed position in FIGS. 7 and 8A and is in the open position in FIG. 8. In FIG. 7, door 33 extends generally intermediate edges 34 and 35. When door 33 is open, articles can be placed inside of and removed from body 30. When door 33 is closed, articles are retained in body 30.

FIGS. 9 and 10 illustrate a Christmas ornament utilized in another embodiment of the invention. Ornament 10B include hollow semi-spherical upper portion 41 pivotally connected to hollow semi-spherical lower portion 42 by hinge 51. Wire ornament hangers or other articles are stored in lower portion 42. A circular panel 40 is fixedly or removably secured in upper portion 41. A clasp 43 is secured to the outer edge of portion 41. Clasp 43 includes flap 45 having aperture 46 formed therethrough. Flap 45 is connected to hinge 44. Hinge 44 is secured to top portion 41. Aperture 46 is shaped to receive pin 47 when top portion 41 is closed. In FIGS. 9 and 10, top portion 41 is in an open position. When top portion 41 closes, circular edge 50 contacts and seats on circular edge 48, and upstanding circular lip 49 extends upwardly a short distance into top portion 41. Top portion 41 is provided with a conventional hollow neck 15B shaped and dimensioned to receive a collar unit 70. When top potion 41 is closed, flap 45 is pivoted about hinge 44 such that pin 47 extends through aperture 46.

FIGS. 11 and 12 illustrate a Christmas ornament utilized in another embodiment of the invention. Ornament 10C includes hollow generally spherical body 60 and a conventional hollow neck 15C shaped and dimensioned to receive a collar unit 70. A circular panel 62 is permanently inserted in body 60 to prevent small articles stored in hollow body 60 from exiting through hollow neck 15C. The bottom 64 of body 60 includes an opening shaped to receive a circular panel door 61 connected to body 60 by hinge 63. A clasp or nub 62 is affixed to door and is removably frictionally received by an aperture (not visible) in fastener unit 65 when door 61 is closed. Door 61 is open in FIG. 11 and is closed in FIG. 12.

In use, wire ornament hangers, collar units, springs 72, collars 71, Christmas lights or other desired articles are placed in an ornament 10, 10A, 10B, 10C by opening the ornament in the manner earlier described. After the wire ornament hangers, etc. are placed in the ornament, the ornament is closed. The ornament includes a collar unit 70 on the neck 15, 15A, 15B, 15C as the case may be, and includes a wire ornament hanger 81 with the bottom 82 attached to the eye 72 of unit 70 in conventional fashion.

In one preferred embodiment, the wire ornament hangers are stored by using the hanger 81 on the ornament to hang the ornament on a Christmas tree 80 in the manner depicted in FIG. 14. This maintains the stored wire hangers in a safe place, and in a place that is readily accessed if an individual needs to remove and open the ornament to retrieve wire hangers from the ornament 10, 10A, 10B, 10C.

In another preferred embodiment of the invention, once wire ornament hangers, etc. are placed in an ornament 10 and the ornament is closed, the ornament is placed in the direction of arrow S in FIG. 15 in a storage space 76 in an ornament storage container 75. The container is placed in storage and is retrieved whenever it is desired to access the wire ornament hangers in the ornament 10. In one preferred scenario, the ornament 10 is placed in a container 75 at the end of the Christmas holidays after a Christmas tree is taken down and/or undecorated, and is not retrieved until the subsequent Christmas when a Christmas tree or other Christmas decorations are being set up and/or decorated for the holidays. When it is desired to retrieve wire ornament hangers, they are readily obtained by retrieving container 75, by removing ornament 10 from container 75, by opening ornament 10, and by removing wire ornament hangers. Wire ornament hangers or other articles can be placed in a bag or other container that is placed in ornament 10.

Having described the presently preferred embodiments and best mode of the invention in such terms as to enable those of skill in the art to understand and practice the invention, I Claim:

1. (canceled)

2. (canceled)

3. (canceled)

4. (canceled)

5. A unit to store and dispense Christmas decoration items, said unit comprising, in combination,
(a) a top;
(b) an Christmas ornament hanger attached to said top;
(c) a hollow body connected to said top and having
(i) an interior portion spaced apart from said top, and
(ii) an exterior shape and dimension and appearance of a Christmas ornament;
(d) decoration articles removably stored in said interior portion, said articles selected from a group consisting of wire ornament hangers, wire ornament springs, and Christmas tree lights; and,
(e) a manually operable structure to access said interior portion of said interior of said body and having at least two operative positions,
(i) a first open dispensing operative position to access said interior portion to remove said decoration articles, and
(ii) a second closed position to seal said articles in said interior portion of said Christmas ornament.

6. A unit to store and dispense Christmas decoration items, said unit comprising, in combination,
(a) a Christmas tree; and
(b) a storage and dispensing unit hanging on said Christmas tree, said ornament comprising
(i) a top,
(ii) a Christmas ornament hanger attached to said top and to said Christmas tree,
(iii) a hollow body connected to said top and having
an interior portion spaced apart from said top, and
an exterior shape and dimension and appearance of a Christmas ornament,
(iv) decoration articles removably stored in said interior portion, said articles selected from a group consisting of wire ornament hangers, wire ornament springs, and Christmas tree lights, and
(v) a manually operable structure to access said interior portion of said interior of said body and having at least two operative positions,
a first open operative position to access said interior portion to remove said articles, and
a second closed position to seal said articles in said interior portion.

7. A unit to store and dispense Christmas decoration items, said unit comprising, in combination,
(a) a top;
(b) a Christmas ornament hanger attached to said top;
(c) a first hollow body member connected to said top and having
(i) a first interior portion, and
(ii) an exterior;
(d) a second hollow body member spaced apart from said top and detachably connected to said first hollow body member and having
(i) a second interior portion spaced apart from said top, and
(ii) an exterior, said exterior of said first hollow body member and said exterior of said second hollow body member having, in combination, a shape and dimension and appearance of a Christmas ornament;
(e) decoration articles removably stored in said second interior portion, said articles selected from a group consisting of wire ornament hangers, wire ornament springs, and Christmas tree lights; and,
(f) a divider removably secured to one of a pair consisting of said first hollow body member and said second hollow body member to
(i) separate said first interior portion and said second interior portion, and
(ii) when removed, access said second interior portion to dispense said decoration articles therefrom.
